(19) United States
(12) Patent Application Publication
(10) Pub. No.: US 2003/0173788 A1
(43) Pub. Date: Sep. 18, 2003

(54) Recovery device and unit

(76) Inventors: James Fussell, Cheltenham (GB); Anna Jane Fussell, Cheltenham (GB)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/388,339

(22) Filed: Mar. 13, 2003

(30) Foreign Application Priority Data
Mar. 14, 2002 (GB) 0205995.4

(51) Int. Cl. B25J 1/04

(52) U.S. Cl. 294/19.1

(57) ABSTRACT

According to a first aspect there is provided a recovery device comprising a body member defining a first and second location: the first location comprising a surface coated with an adhesive material and the second location comprising a coupling component whereby the device is demountably linkable to a complementary coupling component on a handling means for the device.

According to a second aspect of the present invention there is provided a recovery unit comprising a recovery device according to the first aspect and a longitudinal member having first and second ends the longitudinal member at or near its first end being equipped with a complementary coupling for demountable engagement with the coupling component of the recovery device.

### FIELD OF THE INVENTION

This invention relates to a recovery device and unit. It is particularly concerned with the effective recovery of material which is not readily accessible to a user or material, including debris, with which human contact is deemed undesirable.

### BACKGROUND OF THE INVENTION

Where substantial gatherings of people have occurred on a site a large amount of debris is left on the site which requires removal for a range of reasons including public health and safety. At least some of the debris can be hazardous such as broken glass, drugs or other noxious substances, and containers and dispensing means for such substances; contraceptive devices; and materials such as food stuffs. Often such material can be lifted in bulk without handling by the use of gathering devices such as vacuum cleaners and sweepers. However hazardous debris can often be left in locations which are not readily accessed typically due to obstruction or gradient. In these cases individual operatives need to be used having means for gathering the debris in a way which is not dangerous to the gatherer. The means should be able to cope with hazardous material in a variety of physical forms such as powder, fragments or larger components of solid, plastics, organic or other material. Having been used to gather the material the means should be adapted to readily and controllably release the gathered material into a container for subsequent controlled disposal. The means should preferably not be dependent on an external power supply and should be readily manipulated and preferably sterilisible.

### SUMMARY OF THE INVENTION

According to a first aspect of the present invention there is provided a recovery device comprising a body member defining a first and second location: the first location comprising a surface coated with an adhesive material and the second location comprising a coupling component whereby the device is

According to a first preferred version of the second aspect of the present invention the longitudinal member is equipped at or near its second end with a displaceable means attached to one end of a link whose other end to the one end is associated with the complementary coupling to enable the complementary coupling to be moved between: a first position where the complementary coupling is offered for engagement with the coupling of a recovery device to be used with the longitudinal member; and a second position where the complementary coupling is isolated from engagement as aforesaid.

According to a second preferred version of the second aspect of the present invention there is provided a recovery unit comprising a recovery device according to the first aspect or of any preferred version thereof wherein the body member is adapted for hand held use.

### BRIEF DESCRIPTION OF THE DRAWINGS

An exemplary embodiment of the invention will now be descried with reference to the accompanying drawings of a recovery unit and device of which:

FIG. 1 is a perspective view of part of the recovery unit prior to having a recovery device attached;

FIG. 2 shows in more detail a side view of one end of the part of FIG. 1;

FIG. 3 shows an angled view from the front of a working head forming the other end of the part shown in FIG. 1;

FIG. 4 shows an angled view from behind of the working head of FIG. 3 along with a number of possible recovery devices for coupling to the part of FIGS. 1 and 3 to form as a working combination a recovery unit according to the present invention;

FIG. 5 shows the working head of FIG. 3 being presented to a selected recovery device from the number shown in FIG. 4;

FIG. 6 shows the working head of FIG. 5 having had a recovery device demountably attached to it;

FIG. 7 shows the working head of FIG. 6 with a cover being removed from the recovery device prior to use;

FIGS. 8 to 11 show the recovery unit of FIG. 7 in use for a variety of recovery functions; and

FIG. 12 shows a fresh recovery device being fitted to a recovery unit.

### DETAILED DESCRIPTION OF THE INVENTION

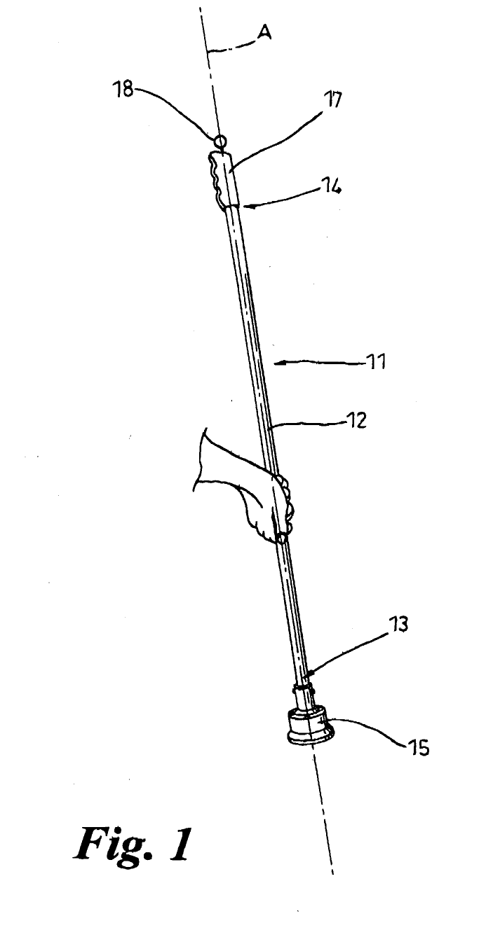

FIG. 1 shows part of recovery unit 11 comprising a shaft 12 with first end 13 and second end 14. The shaft has a longitudinal axis A.

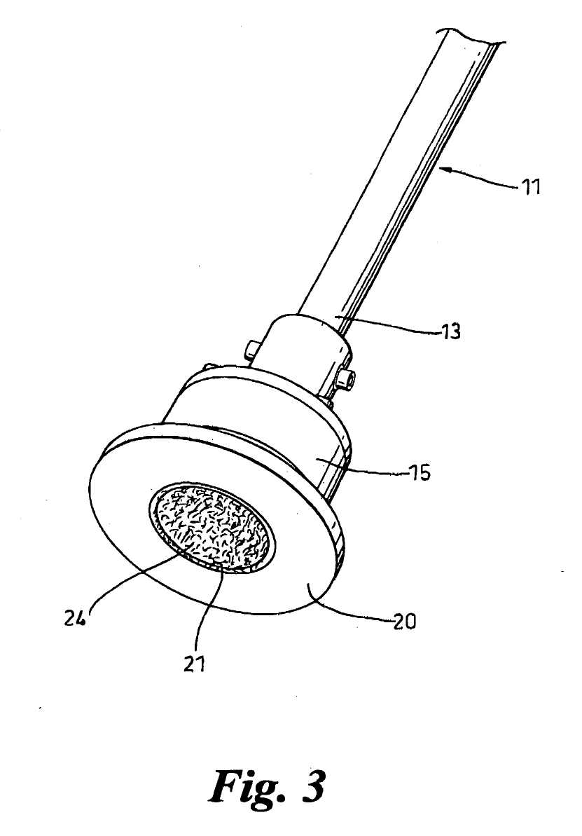

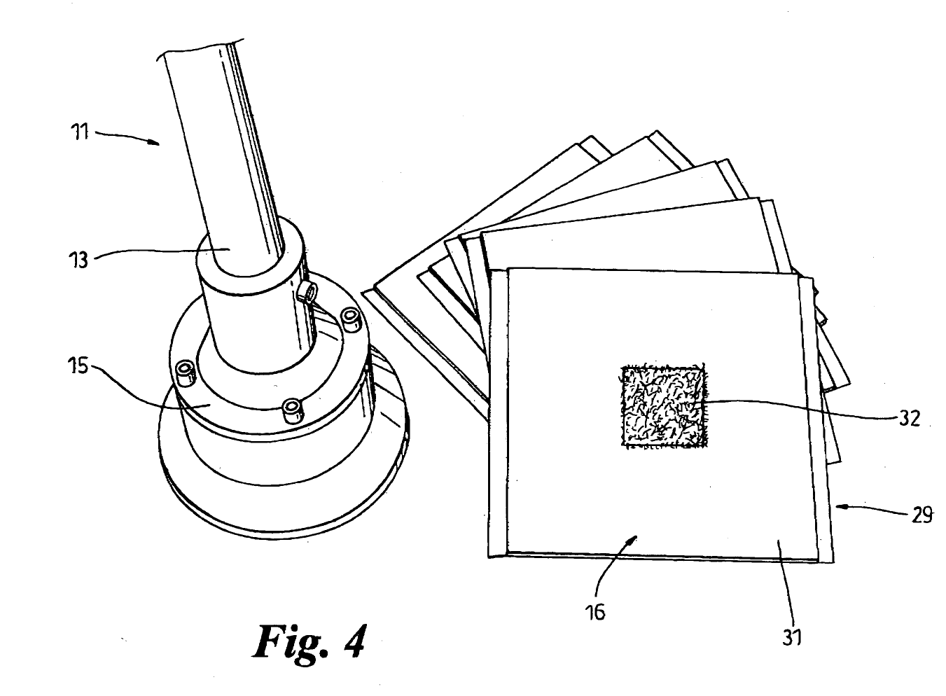

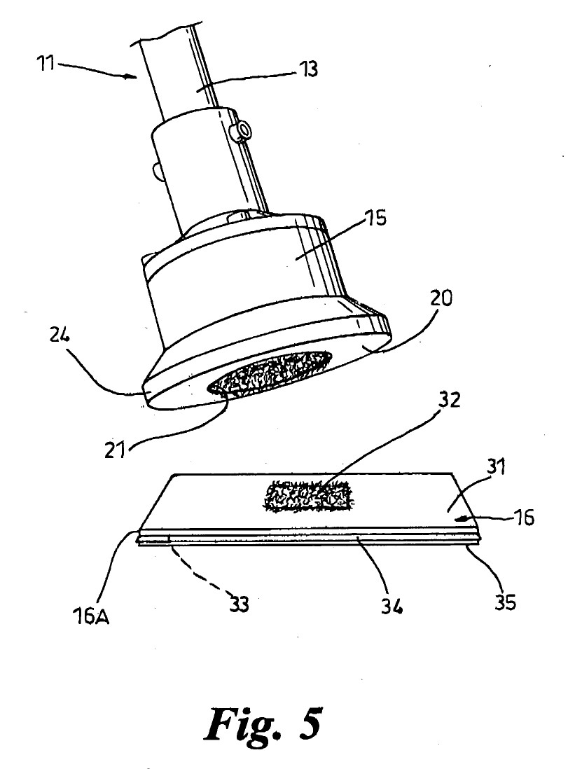

The first end 12 is equipped with collecting head 15 which is used with a recovery device 16 (FIGS. 4, 5) described hereafter in relation to FIGS. 3 to 7 for use in debris collection.

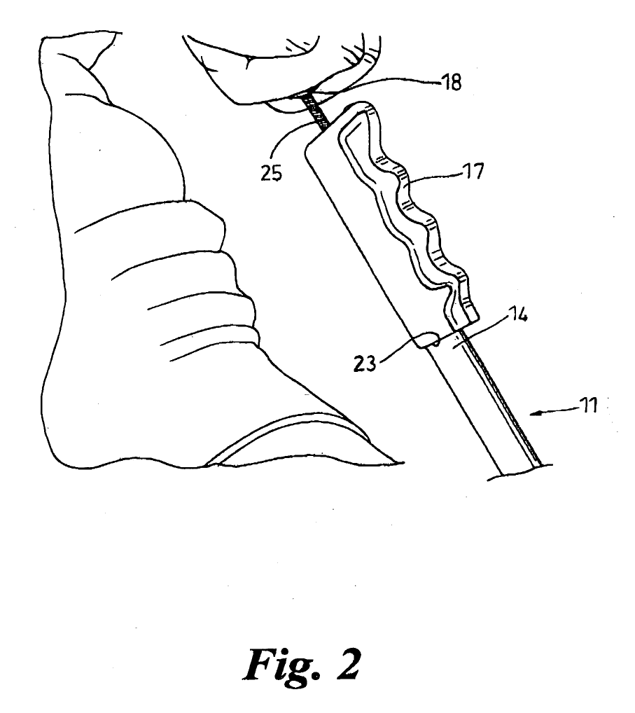

The second end 14 (FIG. 2 showing this in more detail) is equipped with a handling grip 17 and a pull 18 whose function will be described hereafter.

The collecting head 15 will now be described in more detail with reference to FIGS. 3 to 7 which variously show the collecting head being prepared for, and when in, use. The working head 15 has an outward facing end face 20 having a central aperture 21 opening into a bore extending uninterruptedly through shaft 12 to a further aperture 23 at second end 14.

The end face 20 serves to support a recovery device 16 (see FIGS. 4 to 7) whose form and function will be described hereafter.

The central aperture 21 and the neighbouring section of the bore into which the aperture 21 opens serves to locate a pad 24 of a hook and loop fastener (such as ‘Velcro’ (RTM)) which can be displaced from the extended position shown in FIGS. 3 and 5 to a position retracted within the bore. The displacement is achieved by means of a link 25 (FIG. 2) extending through the bore between the pad 24 and the pull 18.

In FIG. 2 the pull 18 is shown drawn upwardly resulting in the link 25 drawing the pad 24 through the aperture 21 into the bore. In this way the pad 24 is detached from anything with which it was demountably engaged.

This invention relates to a recovery device and unit. It is particularly concerned with the effective recovery of material which is not readily accessible to a user or material, including debris, with which human contact is deemed undesirable.

Where substantial gatherings of people have occurred on a site a large amount of debris is left on the site which requires removal for a range of reasons including public health and safety. At least some of the debris can be hazardous such as broken glass, drugs or other noxious substances, and containers and dispensing means for such substances; contraceptive devices; and materials such as food stuffs. Often such material can be lifted in bulk without handling by the use of gathering devices such as vacuum cleaners and sweepers. However hazardous debris can often be left in locations which are not readily accessed typically due to obstruction or gradient. In these cases individual operatives need to be used having means for gathering the debris in a way which is not dangerous to the gatherer. The means should be able to cope with hazardous material in a variety of physical forms such as powder, fragments or larger components of solid, plastics, organic or other material. Having been used to gather the material the means should be adapted to readily and controllably release the gathered material into a container for subsequent controlled disposal. The means should preferably not be dependent on an external power supply and should be readily manipulated and preferably sterilisible.

According to a first aspect of the present invention there is provided a recovery device comprising a body member defining a first and second location: the first location comprising a surface coated with an adhesive material and the second location comprising a coupling component whereby the device is demountably linkable to a complementary coupling component on a handling means for the device.

According to a first preferred version of the first aspect of the present invention the body member comprises a sheet of material having first and second sides; the first side forming the first location and the second side incorporating the second location.

According to a second preferred version of the first aspect of the present invention or of the first preferred version thereof the adhesive coated on the surface of the first location is of a type adapted to retain debris briefly urged into contact with the adhesive. Typically the adhesive is adapted to retain debris which is itself liquid coated or is submerged in a liquid.

In a given embodiment of the second preferred version of the first aspect of the present invention the surface of the first location is of a type adapted to adhere to a relatively rigid article with which the surface is brought into contact while allowing of the subsequent removal of the article from the surface without damage to the article.

According to a third preferred version of the first aspect of the present invention or of any preceding preferred version thereof the coupling is embodied in one of the following: a hook and loop fastener; a magnetic device, a suction means or an adhesive.

According to a fourth preferred version of the first aspect of the present invention or of any preceding preferred version thereof recovery device the body member is flexible and the first location is thereby enabled to deform in use.

According to a second aspect of the present invention there is provided a recovery unit comprising a recovery device according to the first aspect or of any preferred version thereof and a longitudinal member having first and second ends: the longitudinal member at or near its first end being equipped with a complementary coupling for demountable engagement with the coupling component of the recovery device. Typically the longitudinal member is equipped or adapted at or near its second end for handling the unit in use.

According to a first preferred version of the second aspect of the present invention the longitudinal member is equipped at or near its second end with a displaceable means attached to one end of a link whose other end to the one end is associated with the complementary coupling to enable the complementary coupling to be moved between: a first position where the complementary coupling is offered for engagement with the coupling of a recovery device to be used with the longitudinal member; and a second position where the complementary coupling is isolated from engagement as aforesaid.

According to a second preferred version of the second aspect of the present invention there is provided a recovery unit comprising a recovery device according to the first aspect or of any preferred version thereof wherein the body member is adapted for hand held use.

An exemplary embodiment of the invention will now be descried with reference to the accompanying drawings of a recovery unit and device of which:

FIG. 1 is a perspective view of part of the recovery unit prior to having a recovery device attached;

FIG. 2 shows in more detail a side view of one end of the part of FIG. 1;

FIG. 3 shows an angled view from the front of a working head forming the other end of the part shown in FIG. 1;

FIG. 4 shows an angled view from behind of the working head of FIG. 3 along with a number of possible recovery devices for coupling to the part of FIGS. 1 and 3 to form as a working combination a recovery unit according to the present invention;

FIG. 5 shows the working head of FIG. 3 being presented to a selected recovery device from the number shown in FIG. 4;

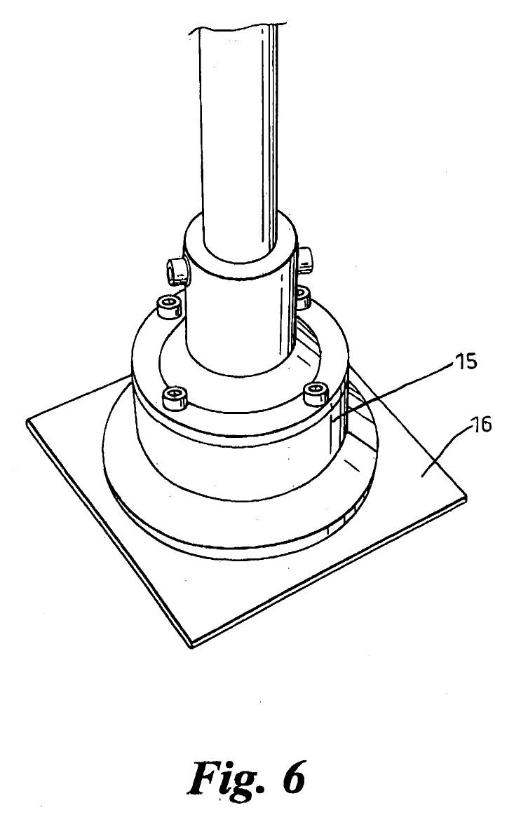

FIG. 6 shows the working head of FIG. 5 having had a recovery device demountably attached to it;

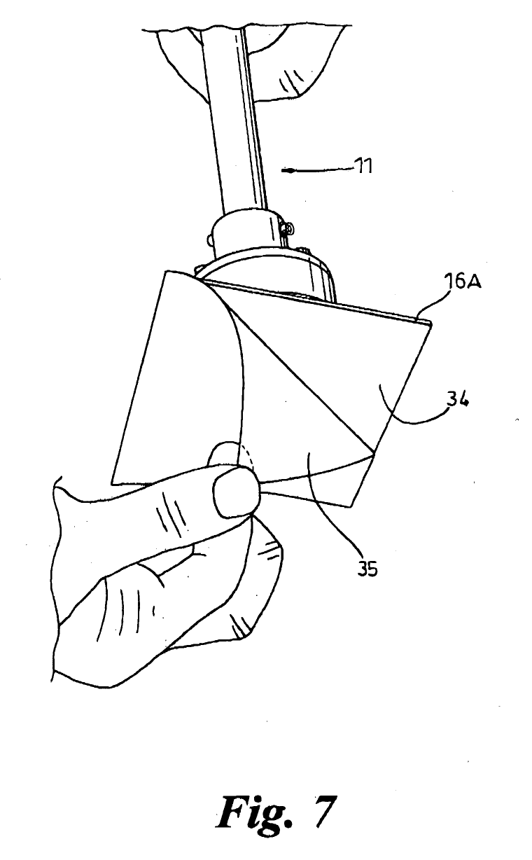

FIG. 7 shows the working head of FIG. 6 with a cover being removed from the recovery device prior to use;

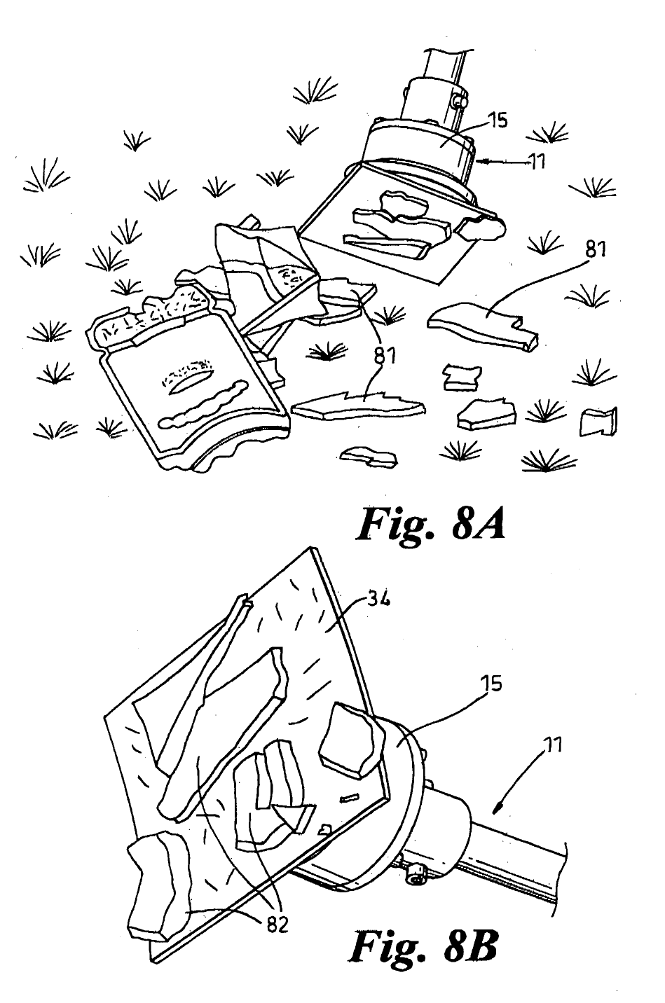

FIGS. 8 to 11 show the recovery unit of FIG. 7 in use for a variety of recovery functions; and

FIG. 12 shows a fresh recovery device being fitted to a recovery unit.

FIG. 1 shows part of recovery unit 11 comprising a shaft 12 with first end 13 and second end 14. The shaft has a longitudinal axis A.

The first end 12 is equipped with collecting head 15 which is used with a recovery device 16 (FIGS. 4, 5) described hereafter in relation to FIGS. 3 to 7 for use in debris collection.

The second end 14 (FIG. 2 showing this in more detail) is equipped with a handling grip 17 and a pull 18 whose function will be described hereafter.

The collecting head 15 will now be described in more detail with reference to FIGS. 3 to 7 which variously show the collecting head being prepared for, and when in, use. The working head 15 has an outward facing end face 20 having a central aperture 21 opening into a bore extending uninterruptedly through shaft 12 to a further aperture 23 at second end 14.

The end face 20 serves to support a recovery device 16 (see FIGS. 4 to 7) whose form and function will be described hereafter.

The central aperture 21 and the neighbouring section of the bore into which the aperture 21 opens serves to locate a pad 24 of a hook and loop fastener (such as ‘Velcro’ (RTM)) which can be displaced from the extended position shown in FIGS. 3 and 5 to a position retracted within the bore. The displacement is achieved by means of a link 25 (FIG. 2) extending through the bore between the pad 24 and the pull 18.

In FIG. 2 the pull 18 is shown drawn upwardly resulting in the link 25 drawing the pad 24 through the aperture 21 into the bore. In this way the pad 24 is detached from anything with which it was demountably engaged.

FIG. 4 shows the collecting head 15 located near a pile 29 of recovery devices of which device 16 is typical. Device 16 has on rear face 31 a central pad 32 of a hook and loop fastener complementing the material of pad 24 to provide for demountable coupling between the device 16 and the collecting head 15.

FIG. 5 shows the collecting head 15 being positioned above the device 16 prior to demountably coupling the head 15 and the device 16. The device 16 has a body 16A with a front face 33 on which is provided an adhesive layer 34 which, as shown, is provided with a cover sheet 35 which serves to isolate the adhesive layer 34 until the unit is to be used. The body 16A is made of a plastics material which while being relatively stiff can flex to a limited extent under contact pressure.

FIG. 6 shows the collecting head 15 with the device 16 seated on the end face 20 and retained snugly there by engagement between pad 24 and pad 32.

FIG. 7 shows the assembled recovery unit 11 being prepared for use by removing the sheet 35 to expose the adhesive layer 34 on body 16A. The adhesive forming the layer 34 is selected depending on the function to be served by the unit. In this case the layer serves to adhere to most types of debris likely to be encountered and can function with wet articles and under water when required.

Typical uses are exemplified in FIGS. 8 to 11.

FIG. 8A shows the prepared unit being 11 being brought into engagement with parts 81 of a broken bottle left on a grassy surface. The collecting head 15 is positioned over the main mass of debris and then pressed gently into engagement with the debris. FIG. 8B shows a collection 82 of material retained on the adhesive layer 34. The action can then be repeated to enable previously vacant sites on the layer 34 to engage with further debris.

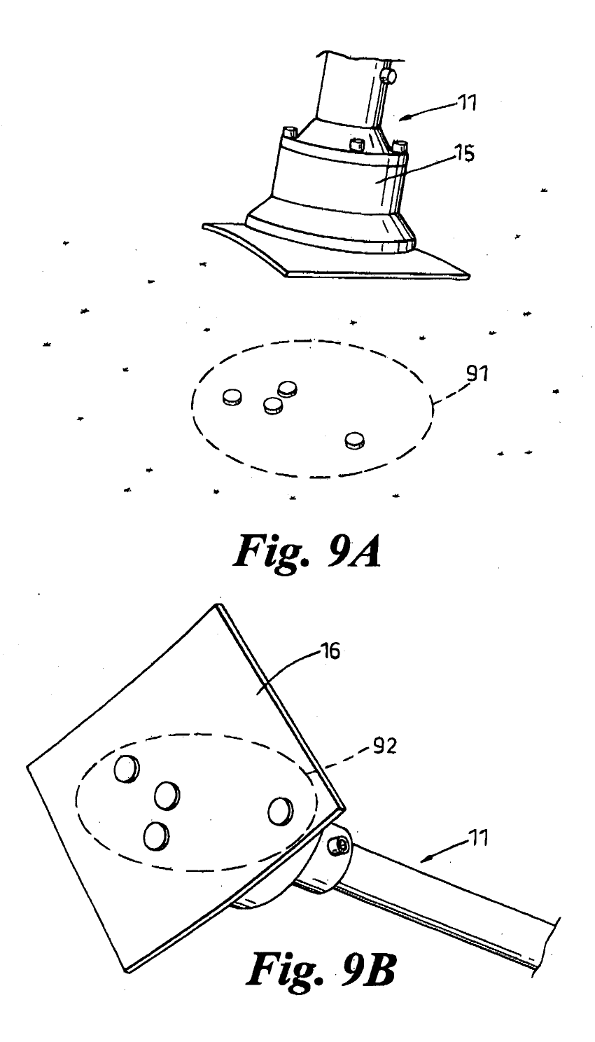

FIG. 9A shows the prepared unit 11 being used for a collection 91 of pills on a carpeted area. FIG. 9B shows the resulting collection 92 of pills collected by means of the device 16.

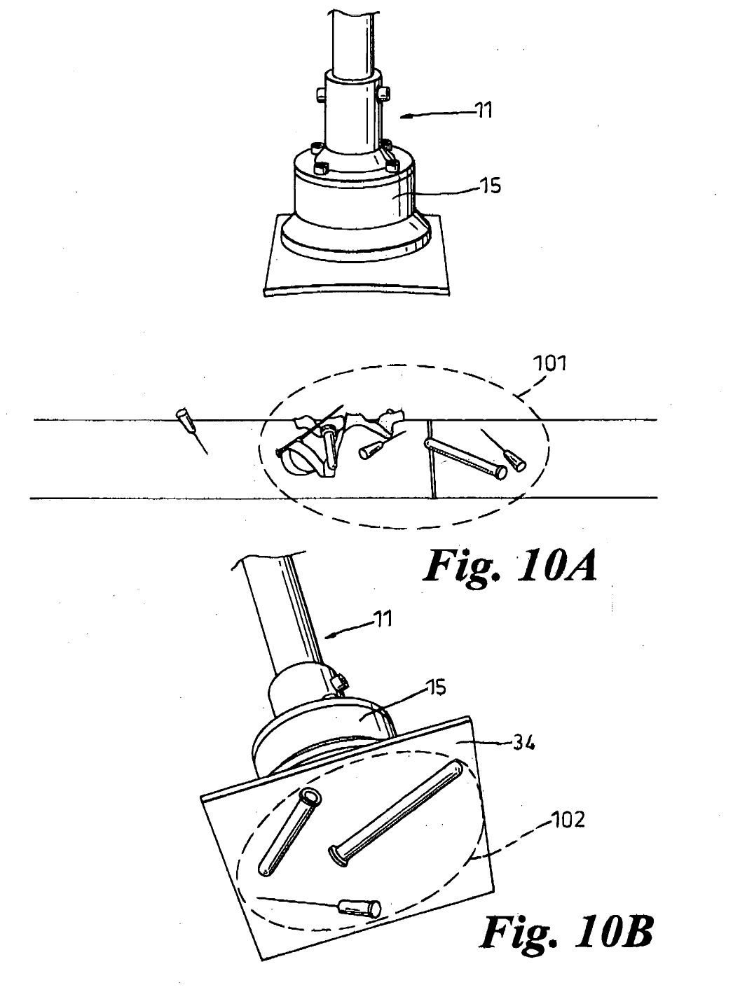

FIG. 10A shows an article of furniture on which debris 101 made up of syringes, drug containers, and tourniquets have been left. The unit 11 is directed downwardly onto contact with the debris. FIG. 10B shows collected material 102 retained by the adhesive layer 34.

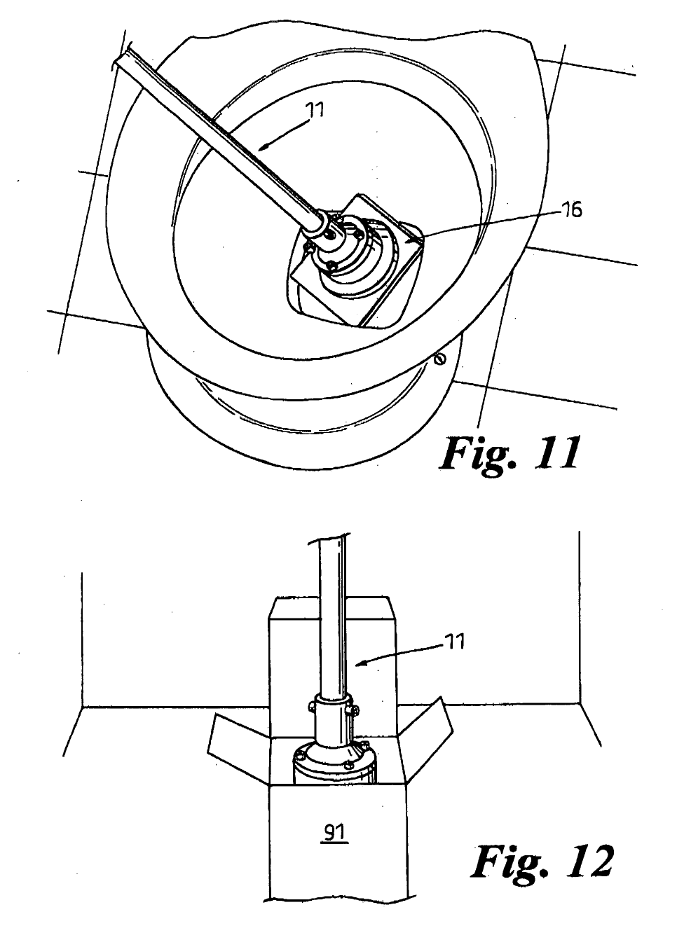

FIG. 11 shows the prepared unit 11 being used to recover debris from a water closet. The adhesive layer used on the underside of the device 16 is relatively unaffected by being immersed in water or by debris which is itself wet.

Once the adhesive layer on device 16 has been covered with adhering debris to the required extent the head 15 is positioned over a disposal bag mounted in a collecting bin. The pull 18 is then drawn so that the link 25 pulls pad 24 into the bore and out of engagement with the pad 32 on the back of device 16. The full device 16 is then released from engagement with the rest of the unit 11 and falls into the disposal bag.

FIG. 12 shows cleared unit 11 being fitted with a further device from a stack of such devices contained in a box 91. This requires the retracted pad 24 to be pushed by means of link 25 out of the bore so as to stand proud of the end face 20 so as to readily engage the complementary pad on an unused device 16.

The present invention provides a cheap recovery unit which is readily prepared for use and used without need for extensive training. The unit is readily manipulated in use and provides for the ready release of a recovery device from the unit bearing a collection of gathered debris. The unit provides for unambiguous usage which does not require any part of the user to contact any debris together with the ability to provide for the ready and controlled release of a collection plate by a simply operated remote control. The recovery unit can be readily cleaned or sterilised during or following use.

While the exemplary embodiment is concerned with the disposal of debris in the form hazardous material the invention is capable of application over a wide range of uses in a range of sizes and for use with debris or other material which is not hazardous and which one collected is not for disposal as waste. Such uses include (but are not limited to): picking up and retaining components used in surgical applications such as sharps; picking up debris generated in the mouth of a dental patient where a conventional suction means is inappropriate or unavailable; handling of small scale components such as electronic items for example by enabling a user to present the component to a particular location prior to a soldering, welding or gluing operation.

The unit as described involves a handle to which the recovery device is attached. However the device can be mounted for use in other ways. This on a small scale version the device can be attached by a strap to an arm or leg of the user so that articles for retention by the adhesive layer can be dropped onto or pressed into contact with the adhesive layer.

Another version of the recovery device according to the present invention involves the use of an adhesive layer where the adhesive is of a type providing for temporary, releasable, retention of an article with which it is brought into contact for the purposes of subsequently recovering the article. Such a version provides for a user to pick up an article which is otherwise out of range. Such a version can be used by an infirm person or an invalid to recovery of an article or in a working environment to reach an article in a store vertically out of reach of from a normal access point.

In a further embodiment the recovery unit of the present invention is equipped with a torch providing a self contained means for illumination of a working area adjacent the head.

The exemplary embodiment describes one simple application of the invention.

Many variations on the example are possible. For example:

the longitudinal body member can be made telescopic to provide for the length to be readily varied for a particular application;

the working head can be equipped with a joint to provide for the recovery device to be set with it working face to be set at an angle to the axis A;

the working head can be mounted on a short handle or the handle can be dispensed with altogether and the head retained by means of, say, a wrist strap;

the fixed adhesive layer 34 of the exemplary embodiment could be replaced by a removable adhesive, for example for non-hazardous applications, which could be readily removed and replaced by a fresh adhesive coating for re-use;

alternatively a multi-layer adhesive systems could be used each layer having a separate backing so that once a layer had been used it could be ripped clear to reveal a fresh adhesive layer.

In the exemplary embodiment the coupling between the working head and the recovery device is in the form of complementary hook and coupling components. Other interacting means can be used to provide for coupling between working head and recovery device can be used. These include:

magnetic means typically by locating a ferromagnetic element in the recovery device and a magnet in the working head,

a suction means typically provide by mans the bore in the handle having housed in it a piston operated by displacing the link so that a vacuum created in the bore serves to retain a recovery device on the outward facing end face of the working head; or

an adhesive layer on the end face of the working head to which the recovery device is readily attached and from which it can be readily detached.

The recovery device can have a body of sheet material selected to have a desired degree of flexibility for a given application. Thus in a situation where debris is on a floor close to a wall it is desirable that the unit should be capable of being presented in such a way that the recovery device flexes sufficiently to enter into the corner between the floor and the wall to ensure that sizeable debris is collected in a single pass.

1. A recovery device comprising a body member defining a first and second location: the first location comprising a surface coated with an adhesive material and the second location comprising a coupling component whereby the device is demountably linkable to a complementary coupling component on a handling means for the device.

2. A recovery device as claimed in claim 1 wherein the body member comprises a sheet of material having first and second sides; the first side forming the first location and the second side incorporating the second location.

3. A recovery device as claimed in any preceding claim wherein the adhesive coated on the surface of the first location is of a type adapted to retain debris briefly urged into contact with the adhesive.

4. A recovery device as claimed in claim 3 wherein the adhesive is adapted to retain debris which is itself liquid coated or is submerged in a liquid.

5. A recovery devices as claimed in claim 2 wherein the adhesive coated on the surface of the first location is of a type adapted to adhere to a relatively rigid article with which the surface is brought into contact while allowing of the subsequent removal of the article from the surface without damage to the article.

6. A recovery device as claimed in any preceding claim wherein the coupling is embodied one of the following: a hook and loop fastener; a magnetic device, a suction means or an adhesive.

7. A recovery device as claimed in any preceding claim wherein the body member is flexible and the first location is thereby enabled to deform in use.

8. A recovery unit comprising a recovery device as claimed in any preceding claim and a longitudinal member having first and second ends—the longitudinal member at or near its first end being equipped with a complementary coupling for demountable engagement with the coupling component of the recovery device.

9. A recovery unit as claimed in claim 8 wherein the longitudinal member is equipped or adapted at or near its second end for handling the unit in use.

10. A recovery unit as claimed in claim 8 or claim 9 wherein the longitudinal member is equipped at or near its second end with a displaceable means attached to one end of a link whose other end to the one end is associated with the complementary coupling to enable the complementary coupling to be moved between:
a first position where the complementary coupling is offered for engagement with the coupling of a recovery device to be used with the longitudinal member; and
a second position where the complementary coupling is isolated from engagement as aforesaid.

11. A recovery unit comprising a recovery device as claimed in claim 1 to claim 7 wherein the body member is adapted for hand held use.

12. A recovery device as hereinbefore described with reference to the accompanying drawings.

13. A recovery unit as hereinbefore described with reference to the accompanying drawings.
